(19) United States
(12) Patent Application Publication
(10) Pub. No.: US 2026/0302609 A1
(43) Pub. Date: Oct. 1, 2026

(54) ELECTRONIC DEVICE

(71) Applicant: Sony Interactive Entertainment Inc., Tokyo (JP)

(72) Inventors: Kota Hatano, Tokyo (JP); Sho Kobayashi, Tokyo (JP); Kazuya Odagiri, Tokyo (JP)

(21) Appl. No.: 19/475,640

(22) PCT Filed: Apr. 21, 2023
(86) PCT No.: PCT/JP2023/016003

§ 371 Date: Oct. 15, 2025

(51) Int. Cl. H01Q 1/52; H01Q 1/48

(52) U.S. Cl. CPC H01Q 1/528; H01Q 1/48; H01Q 1/521

(57) ABSTRACT

Provided is an electronic device including a substrate (10), a first antenna (20) and a second antenna (30) formed on the substrate (10) and each configured to perform wireless communication, a ground pattern (11) formed by a single conductor layer of the substrate (10), and a slit (40) formed by cutting out the conductor layer, with a base point that is a point on an outer periphery of the ground pattern (11), in which the first antenna (20) is disposed within a first antenna region (21) surrounded by an outer periphery of the substrate (10) and the conductor layer in plan view, the second antenna (30) is disposed within a second antenna region (31) surrounded by the outer periphery of the substrate (10) and the conductor layer in plan view, the base point of the slit (40) is located between the first antenna region (21) and the second antenna region (31) in plan view, and the slit (40) has a portion opposing an end portion on a side opposite to a side of the outer periphery of the substrate (10) of the first antenna region (21) in plan view.

### TECHNICAL FIELD

The present invention relates to an electronic device including an antenna for wireless communication.

### BACKGROUND ART

Electronic devices including antennas for performing wireless communication connections with other communication devices, such as wireless local area network (LAN) communication based on the Institute of Electrical and Electronics Engineers (IEEE) 802.11 standard or wireless communication based on the Bluetooth (registered trademark) standard, have been known. As one type of such an antenna, there is a pattern antenna formed by a conductor layer on a front surface of a printed circuit board or the like.

### SUMMARY

### Technical Problem

Among the electronic devices as described above, some include a plurality of antennas. In a case where a plurality of antennas are formed on a single substrate, there is a risk that these antennas mutually interfere due to radiation current propagating through the conductor layer on the printed circuit board and thereby adversely affecting wireless communication.

The present invention has been made in view of the above-mentioned circumstances, and it is an object thereof to provide an electronic device capable of suppressing the propagation of radiation current by an antenna mounted on a substrate.

### Solution to Problem

An electronic device according to the present invention includes a substrate, a first antenna and a second antenna formed on the substrate and each configured to perform wireless communication, a ground pattern formed by a single conductor layer of the substrate, and a slit formed by cutting out the conductor layer, with a base point that is a point on an outer periphery of the ground pattern, in which the first antenna is disposed within a first antenna region surrounded by an outer periphery of the substrate and the conductor layer in plan view, the second antenna is disposed within a second antenna region surrounded by the outer periphery of the substrate and the conductor layer in plan view, the base point of the slit is located between the first antenna region and the second antenna region in plan view, and the slit has a portion opposing an end portion on a side opposite to a side of the outer periphery of the substrate of the first antenna region in plan view.

### BRIEF DESCRIPTION OF DRAWINGS

FIG. 1 is a perspective view illustrating an appearance of a substrate built into an electronic device according to an embodiment of the present invention.

FIG. 2 is a partial plan view illustrating the substrate built into the electronic device according to the embodiment of the present invention.

FIG. 3 depicts diagrams illustrating examples of distributions of radiation current in the electronic device according to the embodiment of the present invention.

FIG. 4 is a diagram illustrating examples of simulation results of antenna-to-antenna isolation in the electronic device according to the embodiment of the present invention.

FIG. 5 is a partial plan view of a substrate built into an electronic device according to a modification example of the present invention.

FIG. 6 is a partial plan view of a substrate built into an electronic device according to another modification example of the present invention.

FIG. 7 is a partial plan view of a substrate built into an electronic device according to a modification example of the present invention in which a meander-shaped slit is formed.

FIG. 8 is a partial plan view of a front surface side of a substrate in a modification example of the present invention in which an antenna and a slit are formed in different conductor layers.

FIG. 9 is a partial plan view of a back surface side of the substrate in the modification example of the present invention in which the antenna and the slit are formed in the different conductor layers.

FIG. 10 is a partial plan view of a substrate built into an electronic device according to a modification example of the present invention in which a plurality of slits are formed.

### DESCRIPTION OF EMBODIMENT

Now, an embodiment of the present invention is described in detail on the basis of the drawings.

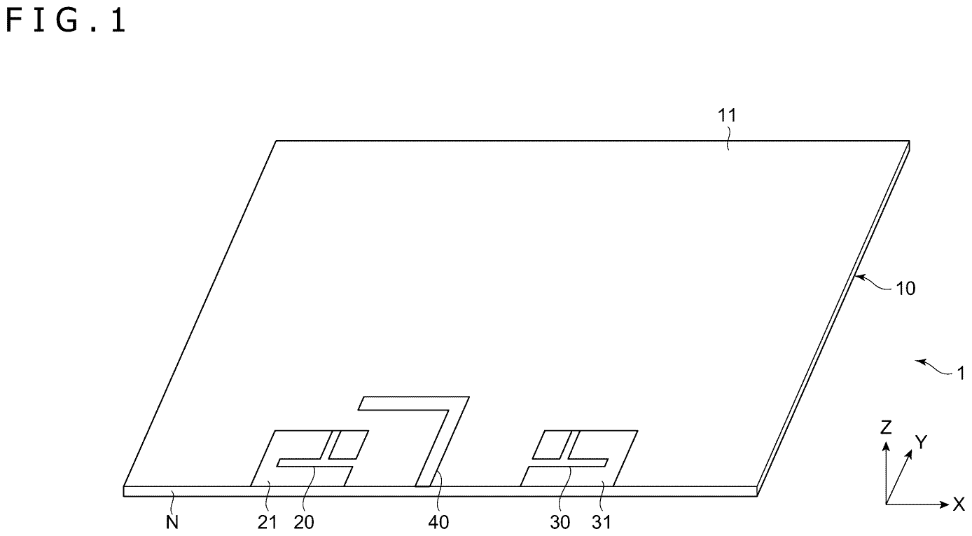

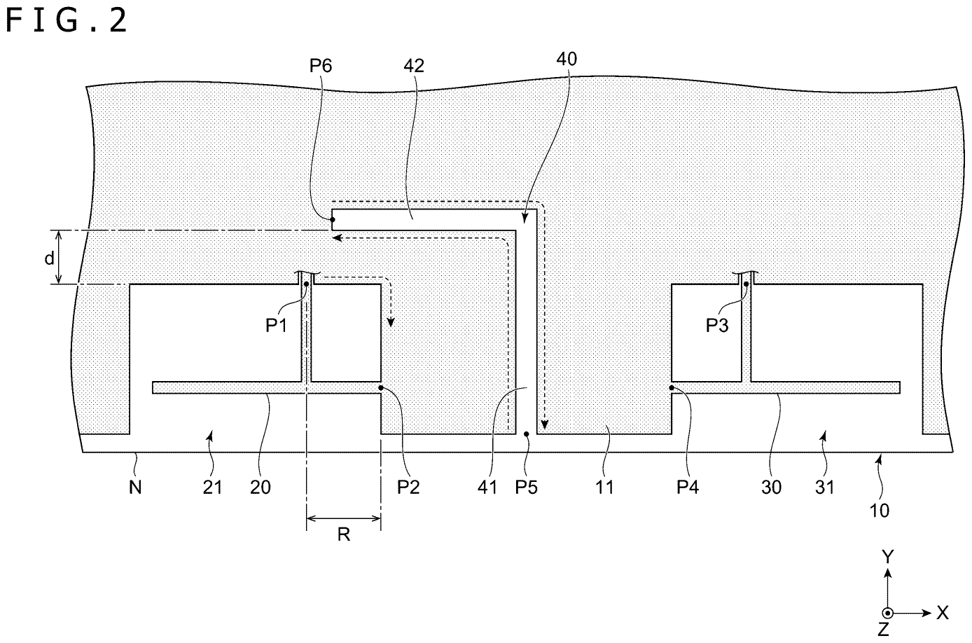

An electronic device 1 according to one embodiment of the present invention is, for example, a personal computer, a home video game console, a handheld game console, or a smartphone, and includes a substrate 10, a first antenna 20, and a second antenna 30. FIG. 1 is a perspective view illustrating an example of an appearance of the substrate 10 built into the electronic device 1. Further, FIG. 2 is a partial plan view illustrating a part of the substrate 10 in an enlarged manner. Note that all drawings including the following drawings are schematic diagrams for the description of features of the electronic device 1 according to the present embodiment, and a scale and the like differ from the actual ones. Furthermore, parts not directly related to the description of this specification are omitted as appropriate.

The substrate 10 is an electronic circuit board on which various circuit elements for achieving functions of the electronic device 1 are mounted. In the present embodiment, the substrate 10 has a flat plate shape of a rectangular shape in plan view as illustrated in FIG. 1. Hereinafter, for convenience of description, a horizontal direction of the substrate 10 is defined as an X-axis while a vertical direction is defined as a Y-axis, and it is assumed that the substrate 10 is disposed in a direction parallel to the XY plane. Furthermore, the direction orthogonal to the substrate 10 is defined as a Z-axis, the direction toward a front surface side of the substrate 10 is defined as a positive Z-axis direction, and the direction toward a back surface side is defined as a negative Z-axis direction. On the front surface of the substrate 10, a ground pattern 11 is formed by a conductor layer over substantially the entire surface. Note that, in FIG. 2, a portion in which the conductor layer is formed of the front surface of the substrate 10 is indicated by hatching.

The first antenna 20 and the second antenna 30 are both circuit elements for enabling the electronic device 1 to perform wireless communication with other electronic devices. The first antenna 20 and the second antenna 30 may be antennas for performing wireless communication in accordance with communication standards different from each other, or may be antennas for performing wireless communication in accordance with the same communication standard.

In the present embodiment, it is assumed that the first antenna 20 and the second antenna 30 are pattern antennas formed by a conductor layer on the front surface of the substrate 10, similarly to the ground pattern 11. Furthermore, the first antenna 20 and the second antenna 30 are both disposed along a single side of the substrate 10. Hereinafter, among the four sides forming the outer periphery of the substrate 10, the single side on which the first antenna 20 and the second antenna 30 are disposed is referred to as a side N. Here, the side N is a side along an X-axis direction.

More specifically, the first antenna 20 is formed by a conductor layer within a first antenna region 21. The first antenna region 21 is a region including the first antenna 20 on the front surface of the substrate 10, and is a region in which no conductor layer is formed other than the first antenna 20. The first antenna region 21 is a substantially rectangular region surrounded by the ground pattern 11 and the outer periphery of the substrate 10 in plan view. A lower side of the first antenna region 21 faces the side N of the substrate 10, and the other three sides are adjacent to the ground pattern 11.

A feeding point P1 of the first antenna 20 is disposed on an upper side of the first antenna region 21 (that is, the side forming the end portion on the side opposite to the outer periphery side of the substrate 10 among the outer periphery of the first antenna region 21). Furthermore, one end of the first antenna 20 is coupled to the ground pattern 11 at a right side of the first antenna region 21 (that is, the side forming the end portion on the side closer to the second antenna 30 among the outer periphery of the first antenna region 21) (point P2 in FIG. 2).

The second antenna 30 is formed by a conductor layer within a second antenna region 31. Similarly to the first antenna region 21, the second antenna region 31 is a region including the second antenna 30 on the front surface of the substrate 10, and is a region in which no conductor layer is formed other than the second antenna 30. The second antenna region 31 is a substantially rectangular region surrounded by the ground pattern 11 and the outer periphery of the substrate 10 in plan view. The lower side of the second antenna region 31 faces the side N of the substrate 10, and the other three sides are adjacent to the ground pattern 11.

Furthermore, the second antenna 30 has a shape substantially symmetrical to that of the first antenna 20, with its center line being a line parallel to the Y-axis. Specifically, a feeding point P3 of the second antenna 30 is disposed on the upper side of the second antenna region 31 (that is, the side forming the end portion on the side opposite to the outer periphery side of the substrate 10 among the outer periphery of the second antenna region 31). Furthermore, one end of the second antenna 30 is coupled to the ground pattern 11 at a left side of the second antenna region 31 (that is, the side forming the end portion on the side closer to the first antenna 20 among the outer periphery of the second antenna region 31) (point P4 in FIG. 2).

It is assumed that the first antenna 20 and the second antenna 30 each perform wireless communication at frequencies that are at least partially in common. For example, it is assumed that the first antenna 20 performs wireless LAN communication based on the IEEE 802.11 standard, and the second antenna 30 performs wireless communication based on the Bluetooth standard. In this case, both perform wireless communication using frequencies near 2.4 GHz. Hereinafter, a wavelength corresponding to the frequency used by the first antenna 20 and the second antenna 30 in common is denoted by λ.

The first antenna 20 and the second antenna 30 each generate radiation current that propagates along the ground pattern 11 when performing wireless communication. There is a risk that such radiation current becomes noise with respect to each other and interferes with the wireless communication of the other. Therefore, in the present embodiment, a slit 40 is formed in the ground pattern 11 between the first antenna 20 and the second antenna 30 by cutting out the conductor layer in an elongated shape. The radiation current mainly propagates along the outer periphery of the ground pattern 11, but with the provision of the slit 40, the current propagates in such a manner as to detour along the outer periphery of the slit 40. At this time, the current flows in opposite directions on the respective sides of the slit 40, so that the radiation current can be prevented from propagating to the opposite side of the slit 40.

A base point P5 of the slit 40 exists at a position between the first antenna region 21 and the second antenna region 31 on the outer periphery of the ground pattern 11. The slit 40 has a linear base portion 41 extending from this base point P5 in a positive Y-axis direction (that is, the rear side of the substrate 10). The slit 40 is bent at a distal end of the base portion 41 (the end portion on the side opposite to the base point P5) at substantially a right angle and further extends in the negative X-axis direction (that is, toward the side closer to the first antenna 20). The portion further extending from the distal end of the base portion 41 of the slit 40 in a bent manner is hereinafter referred to as a bent portion 42. Furthermore, the distal end of the bent portion 42 (that is, the innermost portion of the slit 40) is hereinafter referred to as a distal end P6. The slit 40 has a substantially constant width as a whole, and the width thereof is a width sufficiently smaller than a total length of the slit 40.

The slit 40 can suppress the propagation of radiation current at a wavelength corresponding to an electrical length Le of the slit 40. Therefore, in the present embodiment, a total length L of the slit 40 (that is, the sum of the length of the base portion 41 and the length of the bent portion 42) is set to a length corresponding to a wavelength λ for wireless communication used by the first antenna 20 and the second antenna 30. With this, the slit 40 can suppress the propagation of radiation current that may be generated between the first antenna 20 and the second antenna 30 to adversely affect wireless communication.

Specifically, the electrical length Le of the slit 40 is desirably at least (⅛)λ or more but (⅜)λ or less, and is more desirably a length substantially matching (¼)λ, so as to correspond to the wavelength λ for wireless communication. In the present embodiment, since the slit 40 is formed by a portion in which the conductor layer disposed on the base material of the substrate 10 is cut out, the electrical length Le is calculated by the following formula, where ε represents the relative permittivity of the dielectric forming the base material of the substrate 10.

Le=√ε·L

That is, with the slit 40 formed on a dielectric with a relative permittivity ε, a physical length L of the slit 40 required to suppress radiation current at the same wavelength can be shortened.

Moreover, in the present embodiment, the distal end portion of the slit 40 extends to the left side (the first antenna 20 side) of the right side (that is, the side on the side closer to the slit 40) of the first antenna region 21. With this, there is provided a portion in which the lower side (that is, the side on the side closer to the first antenna region 21) of the distal end portion of the slit 40 and the upper side (that is, the side located on the side closer to the distal end portion of the slit 40 and forming the end portion on the side opposite to the side N of the substrate 10) of the first antenna region 21 both extend substantially parallel along the X-axis direction and oppose each other in plan view.

As indicated by the dashed arrows in FIG. 2, when the first antenna 20 performs wireless communication, radiation current flows from the feeding point P1 toward the slit 40 (that is, rightward) along the outer periphery of the ground pattern 11 adjacent to the first antenna region 21 due to influence. Moreover, the radiation current that has propagated along the outer periphery of the ground pattern 11 flows along the outer periphery of the slit 40 in such a manner as to detour around the slit 40. That is, the radiation current flows leftward along the lower side of the bent portion 42 of the slit 40 toward the distal end P6 of the slit 40. With this, in a portion of the ground pattern 11 sandwiched between the upper side of the first antenna region 21 and the lower side of the bent portion 42 of the slit 40, the mutually oppositely directed currents flow. Such oppositely directed currents have an action of canceling each other, thereby providing an effect of suppressing the propagation of radiation current. In this manner, with the slit 40 formed such that the distal end portion of the slit 40 and the upper side (the side on the side opposite to the outer periphery of the substrate 10) of the first antenna region 21 oppose each other, the propagation of radiation current can be suppressed more compared to a case without any opposing portion.

Note that, to provide an opposing portion between the distal end portion of the slit 40 and the upper side of the first antenna region 21, the position along the side N (that is, the X-axis direction) of the distal end P6 is required to be located on the left side (the first antenna 20 side) of the right side of the first antenna region 21. Meanwhile, even if the bent portion 42 of the slit 40 extends to the left side (the side opposite to the base point P5 side of the slit 40) of the feeding point P1 of the first antenna 20, in the region on the left side of the feeding point P1, the directions of currents flowing in the opposing portion are not opposite, and hence the effect of suppressing the propagation of radiation current is not obtained. Therefore, the position along the side N of the distal end P6 of the slit 40 is desirably located within a range between the end portion on the slit 40 side of the first antenna region 21 and the feeding point P1 (the range indicated by R in FIG. 2).

Furthermore, when a distance between the distal end portion of the slit 40 and the first antenna region 21 is large, the effect of suppressing the propagation of radiation current cannot be sufficiently obtained. The inventors of the present application have found that the effect of suppressing the propagation of radiation current becomes particularly significant through verification including simulations and the like, in a case where a distance d along the Y-axis direction between the lower side of the distal end portion of the slit 40 and the upper side of the first antenna region 21 is set to be equal to or less than 1/16 of the wavelength λ for wireless communication. Note that, in a case where a distance of the opposing portion between the distal end portion of the slit 40 and the first antenna region 21 is not constant, the slit 40 is desirably disposed such that at least the distance d at the portion at which the slit 40 is closest to the first antenna region 21 becomes equal to or less than 1/16 of the wavelength λ.

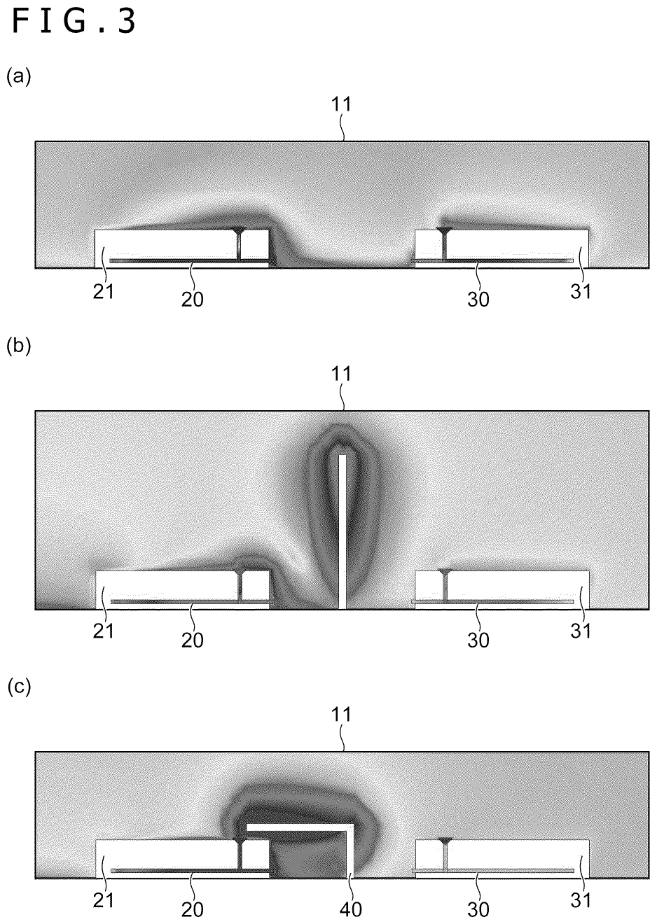

FIG. 3 depicts diagrams for comparing the results of simulations of distributions of radiation current generated in the ground pattern 11 of the substrate 10 in a case where the first antenna 20 executes wireless communication, for a plurality of types of substrates different from each other. Specifically, FIG. 3(a) illustrates a distribution for a case without the slit 40, FIG. 3(b) illustrates a distribution for a case where a linear slit is formed instead of the slit 40, and FIG. 3(c) illustrates a distribution for a case where the L-shaped slit 40 in the present embodiment is formed. Note that, in FIG. 3(b) and FIG. 3(c), the lengths of the slits substantially match each other, and the electrical lengths thereof are lengths corresponding to approximately ¼ of the wavelength λ. Note that, in (a) to FIG. 3(c), areas with a higher degree of shading indicate locations in which large radiation current has been generated.

As illustrated in FIG. 3(a) to FIG. 3(c), in the case without any slit, radiation current generated by the first antenna 20 propagates to the second antenna 30. In contrast to this, in the case where the linear slit is disposed, a relatively large radiation current distribution occurs along the slit, and although radiation current that propagates to the second antenna 30 decreases, the radiation current still propagates to some extent around the second antenna 30 and the second antenna region 31. Meanwhile, in the present embodiment, although a strong radiation current distribution occurs near the bent portion 42, radiation current that propagates beyond the slit 40 to the second antenna 30 side decreases further compared to the case with the linear slit and has almost no influence.

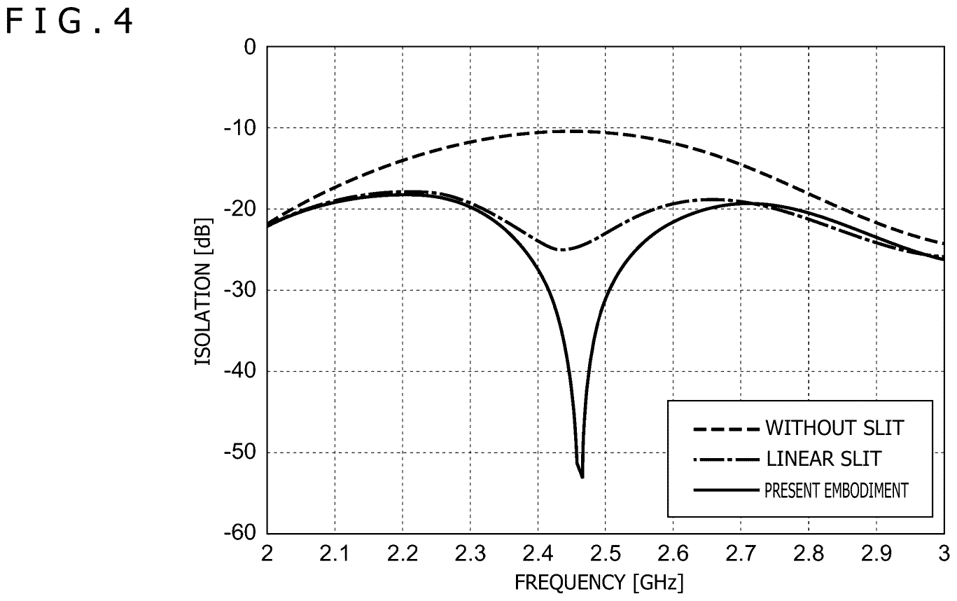

Furthermore, FIG. 4 is a graph illustrating the results of simulations for antenna-to-antenna isolation performance between the first antenna 20 and the second antenna 30. A horizontal axis of the graph represents frequency, and a vertical axis represents an isolation value, where a smaller value indicates better antenna-to-antenna isolation (that is, a smaller degree of mutual influence between the first antenna 20 and the second antenna 30).

This graph also illustrates simulation results for three patterns, namely, a case without any slit, a case where a linear slit is formed, and a case where the L-shaped slit 40 illustrated in FIG. 1 and FIG. 2 is formed, as illustrated in FIG. 3(a), FIG. 3(b), and FIG. 3(c).

Specifically, in the graph, the dashed line represents a simulation result for the case without any slit, the dashed-dotted line represents a simulation result for the case where the linear slit is formed, and the solid line represents a simulation result for the case where the slit 40 in the present embodiment is formed. It has been confirmed that, as illustrated in this graph, according to the present embodiment, isolation is significantly improved near a frequency of 2.4 GHz corresponding to the wavelength λ, compared not only to the case without any slit but also to the case where the linear slit is disposed.

As described above, with the electronic device 1 according to the present embodiment, the slit 40, which has a portion opposing the upper side of the first antenna region 21, is formed in the conductor layer, thereby enabling the suppression of the propagation of radiation current between the first antenna 20 and the second antenna 30 to reduce the mutual interference between the first antenna 20 and the second antenna 30. Particularly, in the present embodiment, since the slit 40 is disposed to improve isolation, it is possible to dispose the first antenna 20 and the second antenna 30 with a distance therebetween reduced to be equal to or less than (¼)λ. With this, the constraints on circuit layout are relaxed. Furthermore, in the present embodiment, the slit 40 has a bent shape, and the distal end portion thereof is disposed at a position relatively close to the first antenna region 21. Therefore, compared to a case where a linear slit is disposed, for example, the space required for disposing the slit 40 is smaller.

Note that it has been assumed that the wavelength λ in the above description is a wavelength corresponding to the wireless communication frequency used by both the first antenna 20 and the second antenna 30. With this, the slit 40 can suppress both radiation current that propagates from the first antenna 20 to the second antenna 30 side and radiation current that propagates from the second antenna 30 to the first antenna 20 side, thereby effectively improving isolation between the first antenna 20 and the second antenna 30. However, an embodiment of the present invention is not limited to such a configuration. It is sufficient if the wavelength λ is a wavelength corresponding to the wireless communication frequency used by the first antenna 20, and the wavelength λ does not need to be a wavelength corresponding to the wireless communication frequency used by the second antenna 30. Even in this case, the slit 40, which has the electrical length Le corresponding to the wavelength λ, is disposed between the first antenna 20 and the second antenna 30 as described above, thereby enabling the suppression of the propagation of radiation current corresponding to the wavelength λ generated from the first antenna 20 to the second antenna 30 side. Furthermore, the distance d between the lower side of the distal end portion of the slit 40 and the upper side of the first antenna region 21 is set to be equal to or less than ( 1/16)λ with respect to the wavelength λ corresponding to the wireless communication frequency used by the first antenna 20, thereby enabling the effective suppression of the propagation of radiation current from the first antenna 20.

### Modification Examples

An embodiment of the present invention are not limited to that described above, and various modifications can be implemented.

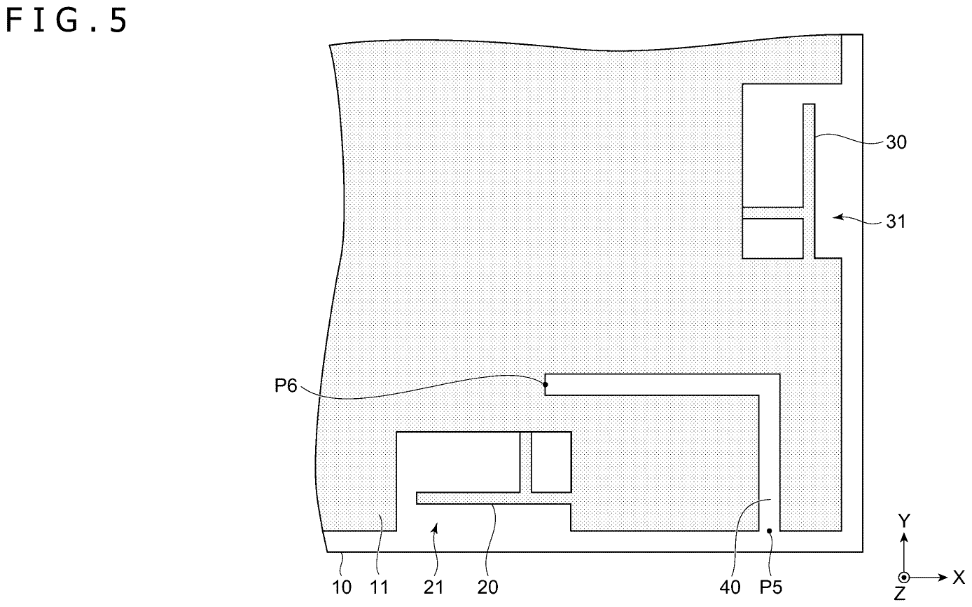

For example, the first antenna 20 and the second antenna 30 may be disposed along different sides on the same substrate 10. FIG. 5 illustrates an example of an electronic device according to such a modification example. In the example of FIG. 5, the first antenna 20 is disposed along the side on the negative Y-axis direction side as in FIG. 1 and FIG. 2, while the second antenna 30 is disposed along a side on the positive X-axis direction side, which is different from the above-mentioned side. Even in this case, as in FIG. 1 and the like, the slit 40, which has the base point P5 on the outer periphery of the ground pattern 11 on the side on which the first antenna 20 is disposed and is bent toward the rear side (the side opposite to the outer periphery of the substrate 10) of the first antenna region 21, is formed. With this, the cancellation of currents occurs in the portion in which the upper side of the first antenna region 21 and the distal end portion of the slit 40 oppose each other, thereby enabling the improvement of isolation between the first antenna 20 and the second antenna 30.

Moreover, in the case where the first antenna 20 and the second antenna 30 are disposed on the sides different from each other, the base point P5 of the slit 40 may be disposed, not along the side on the side on which the first antenna 20 is disposed, but along the side on the side on which the second antenna 30 is disposed. In this case, the slit 40 does not necessarily need to have a bent shape to provide a portion in which the distal end portion of the slit 40 opposes the side on the side opposite to the outer periphery of the substrate 10 of the first antenna region 21.

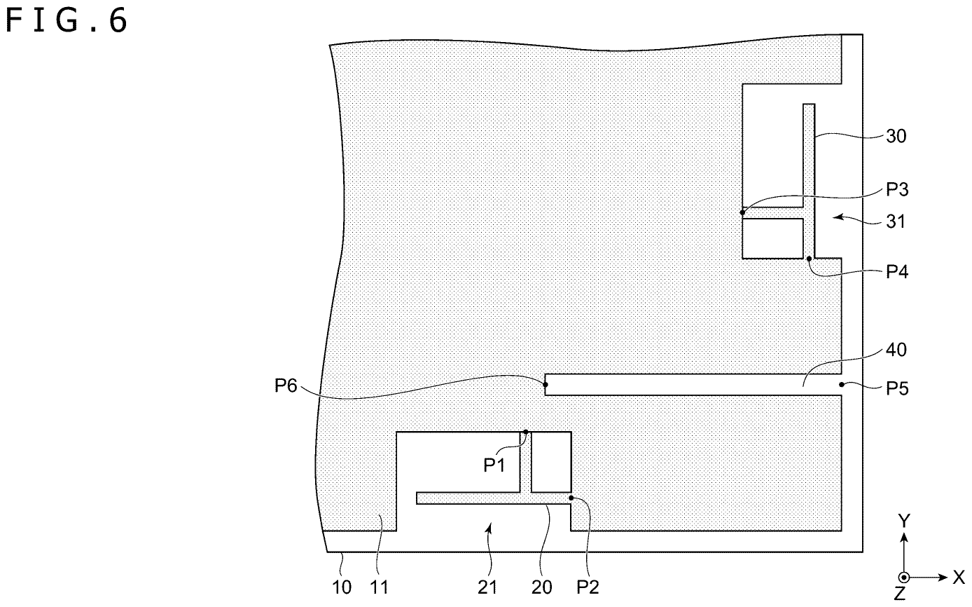

FIG. 6 illustrates an example of an electronic device according to such a modification example. In this example, the slit 40 has the base point P5 on the outer periphery of the ground pattern 11 on the side on which the second antenna 30 is disposed, and has a linear shape extending toward the side on which the first antenna 20 is disposed. Also in this example, the position in the X-axis direction (that is, the direction along the side on which the first antenna region 21 is disposed of the substrate 10) of the distal end P6 of the slit 40 is located between the feeding point P1 of the first antenna 20 and the right side (that is, the side on the side closer to the base point P5 of the slit 40) of the first antenna region 21. With this, the lower side of the distal end portion of the slit 40 opposes the upper side of the first antenna region 21. Mutually oppositely directed radiation currents flow in the conductor layer sandwiched between these two opposing sides, thereby enabling the improvement of isolation between the first antenna 20 and the second antenna 30, as in the example of FIG. 1 and the like.

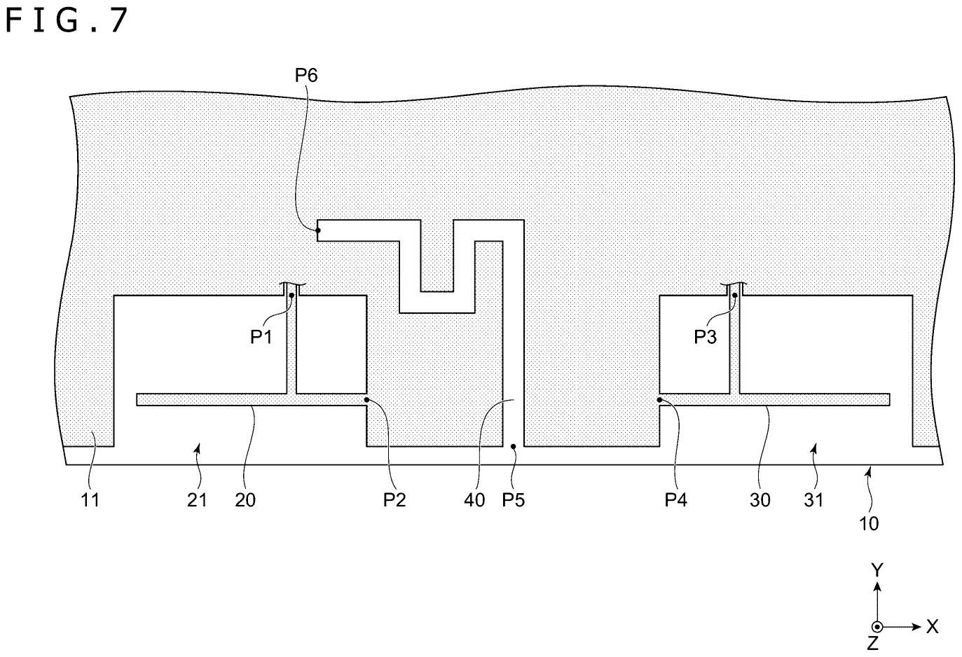

Furthermore, the slit 40 is not limited to that described above and may have various shapes, as long as the slit 40 has, on the distal end side thereof, a portion opposing the upper side of the first antenna region 21. As an example, FIG. 7 illustrates a modification example in which the slit 40 has a meander shape bent at a plurality of locations. Also in this example, the distal end portion of the slit 40 opposes the upper side of the first antenna region 21, and the distal end P6 exists at a position between the right side of the first antenna region 21 and the feeding point P1 of the first antenna 20. With this, isolation between the first antenna 20 and the second antenna 30 can be improved as in the example of FIG. 1 and the like.

Furthermore, in the above description, it has been assumed that the slit 40 is formed on the same conductor layer as the first antenna 20 and the second antenna 30. That is, the first antenna 20, the second antenna 30, and the ground pattern 11 are formed by a single conductor layer on the front surface of the substrate 10, and the slit 40 is formed by cutting out a part of this ground pattern 11. However, the embodiment of the present invention is not limited to such a configuration, and the slit 40 may be formed within a conductor layer different from the conductor layer for both or either of the first antenna 20 and the second antenna 30.

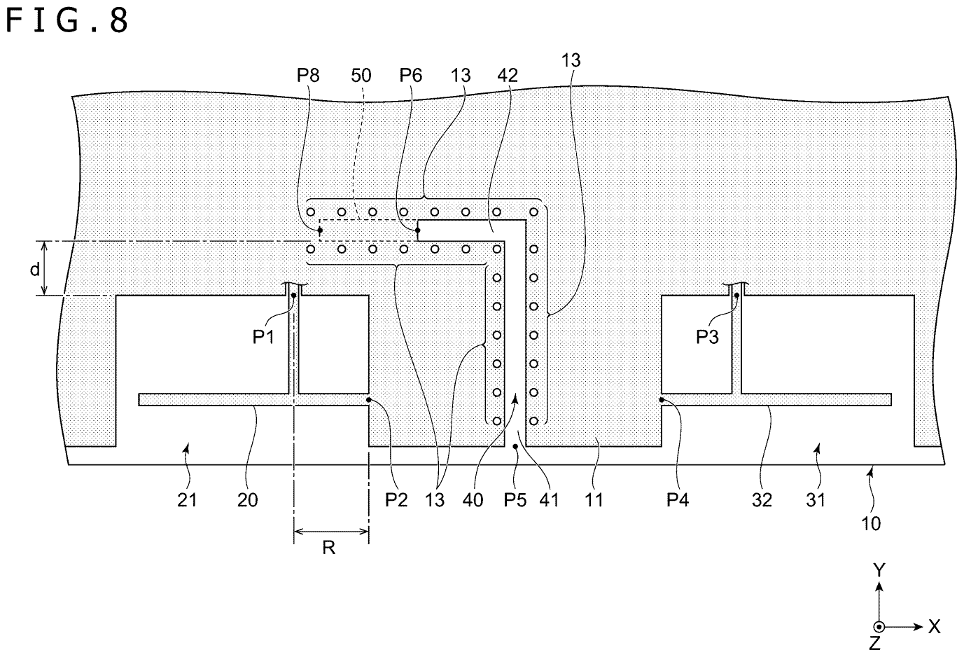

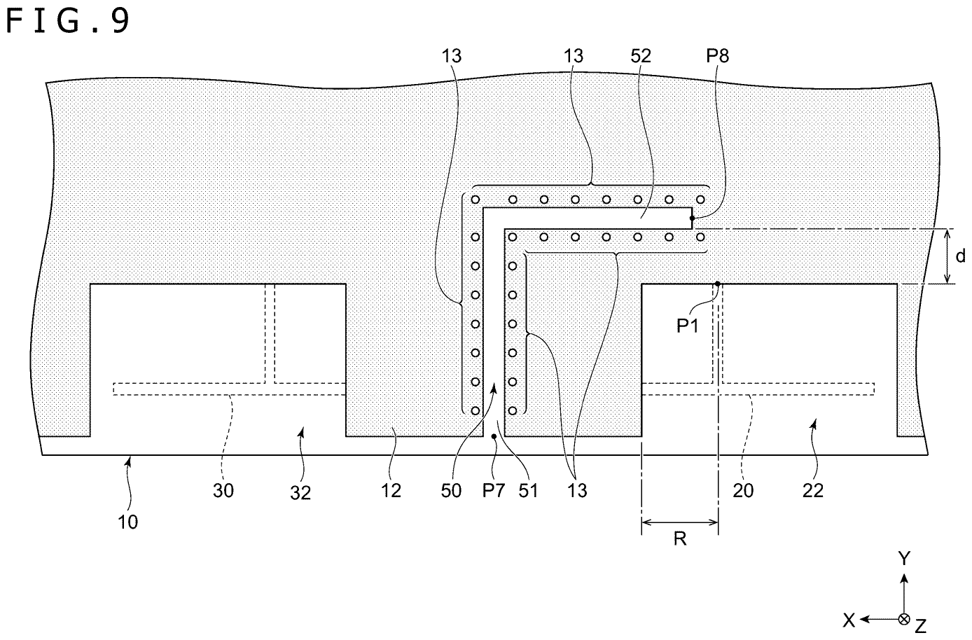

Now, an example of the substrate 10 in an electronic device according to such a modification example is described using FIG. 8 and FIG. 9. FIG. 8 is a partial plan view of the front surface side of the substrate 10, and FIG. 9 is a partial plan view of the back surface side of the substrate 10 at the corresponding position.

In the present modification example, as in the embodiment of FIG. 1, the ground pattern 11, the first antenna 20, and the second antenna 30 are formed by a conductor layer formed on the front surface side of the substrate 10. Furthermore, in the ground pattern 11, the slit 40 is formed with the base point P5 at a position between the first antenna 20 and the second antenna 30. However, unlike in FIG. 1, in the present embodiment, due to the constraints on circuit layout, the length to the distal end of the slit 40 is shorter than that illustrated in FIG. 1, and therefore, the portion opposing the upper side of the first antenna region 21 no longer exists in the distal end portion of the slit 40.

Meanwhile, on the back surface side of the substrate 10, a ground pattern 12 is formed by a conductor layer. In this ground pattern 12, a rectangular region overlapping with the first antenna region 21 on the front surface side in plan view is cut out, and with this, a first back surface region 22 is formed. Furthermore, a rectangular region overlapping with the second antenna region 31 on the front surface side in plan view is cut out, and with this, a second back surface region 32 is formed. That is, the ground pattern 12 on the back surface side is also formed in such a manner as to avoid locations in which the first antenna 20 and the second antenna 30 are formed in plan view, similarly to the ground pattern 11 on the front surface side. Note that, in FIG. 9, the positions of the first antenna 20 and the second antenna 30 are indicated by the dashed lines.

Moreover, in the ground pattern 12, a slit 50 is formed at a position partially overlapping with the slit 40 in plan view. The slit 50 in the present modification example has a shape and a size similar to those of the slit 40 in the embodiment of FIG. 1, and has the electrical length Le corresponding to the wavelength λ as a whole.

Specifically, the slit 50 includes a base portion 51 extending linearly in the positive Y-axis direction (that is, toward the center side of the substrate 10) with a base point P7 at a position matching the base point P5 of the slit 40 in plan view. The base portion 51 matches the base portion 41 of the slit 40 on the front surface side in position, shape, and size.

The slit 50 includes a bent portion 52 bent at the end portion on the side opposite to the base point P7 of the base portion 51 and further extending to the negative X-axis direction side. The bent portion 52 is longer than the bent portion 42 of the slit 40 on the front surface side, and the distal end portion thereof has a portion opposing the first back surface region 22, as in FIG. 1 and the like. That is, in plan view, the position along the X-axis direction of a distal end P8 of the bent portion 52 is located within a range R between the right side (the side forming the end portion on the second antenna 30 side) of the first antenna region 21 and the feeding point P1 of the first antenna 20, and the distal end portion of the bent portion 52 opposes the upper side of the first antenna region 21 in plan view. Furthermore, the distance d in plan view between the lower side of the slit 50 and the upper side of the first antenna region 21 is equal to or less than ( 1/16)λ. Note that the dashed line in FIG. 8 indicates the position of the slit 50 on the back surface side.

Moreover, the ground pattern 11 on the front surface side is electrically connected to the ground pattern 12 on the back surface side to form the ground of a circuit.

Particularly, in the present modification example, along the outer periphery of the slit 50, a plurality of vias 13 penetrating the substrate 10 are disposed at constant intervals around the slit 50, and at the positions of these vias 13, the ground pattern 11 is electrically connected to the ground pattern 12. With this, radiation current generated by the first antenna 20 propagates also to the ground pattern 12 and flows along the outer periphery of the slit 50. Therefore, the slit 50 of the present modification example formed in the ground pattern 12 on the back surface side can suppress the propagation of radiation current between the first antenna 20 and the second antenna 30, thereby improving isolation between the first antenna 20 and the second antenna 30, similarly to the slit 40 on the front surface side in the embodiment of FIG. 1 and the like.

Note that, in the present modification example, it has been assumed that the slit 50 having a portion opposing the upper side of the first antenna region 21 in plan view is formed in the ground pattern 12 on the back surface side. However, the electronic device according to the embodiment of the present invention is not limited to this, and in a case where the substrate 10 is a multilayer substrate, a slit satisfying the requirements described so far may be formed in an inner conductor layer of the substrate 10. Furthermore, slits may be formed in each of a plurality of layers such as a conductor layer on the front surface side, a conductor layer on the back surface side, or an inner conductor layer in such a manner as to overlap in plan view.

Furthermore, in the description so far, it has been assumed that only the single slit 40 with a base point at a position between the first antenna region 21 and the second antenna region 31 is disposed. However, the electronic device according to the embodiment of the present invention may have a plurality of slits formed between the first antenna region 21 and the second antenna region 31.

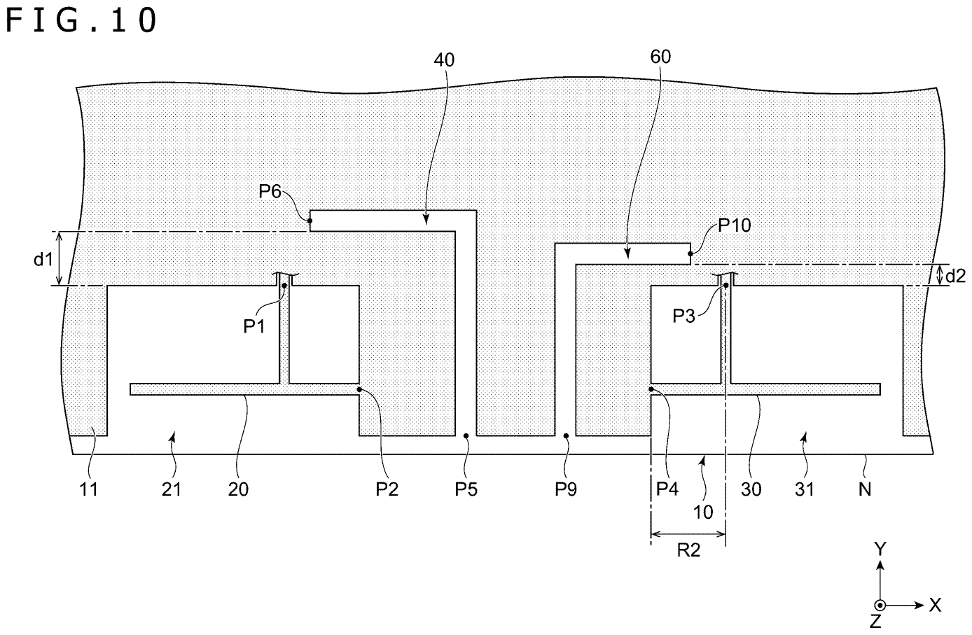

FIG. 10 is a partial plan view of the substrate 10 built into an electronic device according to such a modification example. Note that, in the following description, a wavelength corresponding to the wireless communication frequency used by the first antenna 20 is denoted by λ1, and a wavelength corresponding to the wireless communication frequency used by the second antenna 30 is denoted by λ2. Here, the wavelength λ1 does not necessarily need to correspond to the wireless communication frequency used by the second antenna 30, and a wavelength λ2 does not necessarily need to correspond to the wireless communication frequency used by the first antenna 20. However, in a case where both the wavelengths λ1 and λ2 are wavelengths corresponding to the wireless communication frequencies used by both the first antenna 20 and the second antenna 30, an effect of further improving isolation between the first antenna 20 and the second antenna 30 can be expected. In the following, as a specific example, two frequencies near 2.4 GHz and near 5 GHz are used as the frequencies that the first antenna 20 and the second antenna 30 use for wireless communication, and wavelengths corresponding to the respective frequencies are denoted by λ1 and λ2.

In this example of FIG. 10, the slit 40 has a portion opposing the first antenna region 21 as in the embodiment of FIG. 1 and the like. Furthermore, in this modification example, the electrical length Le of the slit 40 is desirably at least (⅛)λ1 or more but (⅜)λ1 or less, and is more desirably a length substantially matching (¼)λ1, so as to correspond to the wavelength λ1. In the example of FIG. 10, the slit 40 has an electrical length corresponding to ¼ of the wavelength λ1 as a whole. With this, the slit 40 provides an effect of suppressing the propagation of radiation current at the wavelength λ1 between the first antenna 20 and the second antenna 30. Furthermore, a distance d1 between the distal end portion of the slit 40 and the upper side of the first antenna region 21 is equal to or less than 1/16 of λ1.

Meanwhile, separately from the slit 40, a slit 60 having an L shape bent to the second antenna 30 side is formed with a base point P9 on the outer periphery of the ground pattern 11 on the side on which the first antenna 20 and the second antenna 30 are disposed, like the slit 40. The electrical length Le of the slit 60 is desirably at least (⅛)λ2 or more but (⅜)λ2 or less, and is more desirably a length substantially matching (¼)λ2, so as to correspond to the wavelength λ2. In the example of FIG. 10, the slit 60 has an electrical length corresponding to ¼ of the wavelength λ2 as a whole. With this, the slit 60 provides an effect of suppressing the propagation of radiation current at the wavelength λ2 between the first antenna 20 and the second antenna 30.

Besides, the distal end portion of this slit 60 has a portion opposing the upper side of the second antenna region 31 (that is, the side forming the end portion on the side opposite to the outer periphery side of the substrate 10 among the outer periphery of the second antenna region 31). Moreover, the position along the side N (that is, the X-axis direction) of a distal end P10 of the slit 60 is desirably located within the range between the left side (the side forming the end portion on the side closer to the first antenna 20) of the second antenna region 31 and the feeding point P3 of the second antenna 30 (the range indicated by R2 in FIG. 10). Furthermore, a distance d2 between the distal end portion of this slit 60 and the upper side of the second antenna region 31 (that is, the side forming the end portion on the side opposite to the outer periphery side of the substrate 10 among the outer periphery of the second antenna region 31) may be equal to or less than 1/16 of λ2.

With the plurality of slits disposed between the first antenna 20 and the second antenna 30 in this manner, the propagation of radiation currents at a plurality of wavelengths corresponding to the respective electrical lengths can be suppressed.

### REFERENCE SIGNS LIST

1: Electronic device
10: Substrate
11, 12: Ground pattern
20: First antenna
21: First antenna region
30: Second antenna
31: Second antenna region
40, 50, 60: Slit

1. An electronic device comprising:
a substrate;
a first antenna and a second antenna formed on the substrate and each configured to perform wireless communication;
a ground pattern formed by a single conductor layer of the substrate; and
a slit formed by cutting out the conductor layer, with a base point that is a point on an outer periphery of the ground pattern,
wherein
the first antenna is disposed within a first antenna region surrounded by an outer periphery of the substrate and the conductor layer in a plan view,
the second antenna is disposed within a second antenna region surrounded by the outer periphery of the substrate and the conductor layer in the plan view,
the base point of the slit is located between the first antenna region and the second antenna region in the plan view, and
the slit has a portion opposing an end portion on a side opposite to a side of the outer periphery of the substrate of the first antenna region in the plan view.

2. The electronic device according to claim 1, wherein
an opposing portion is a portion in which a distal end portion of the slit opposes the end portion on the side opposite to the side of the outer periphery of the substrate of the first antenna region, and
a position in a direction along the outer periphery of the substrate of a distal end of the slit is located between an end portion on a side of the second antenna of the first antenna region and a feeding point of the first antenna.

3. The electronic device according to claim 1 wherein, in the opposing portion, a distance between the slit and the first antenna region in the plan view is equal to or less than 1/16 of a wavelength corresponding to a wireless communication frequency used by the first antenna.

4. The electronic device according to claim 3, wherein the wavelength is a wavelength corresponding to a wireless communication frequency used by both the first antenna and the second antenna.

5. The electronic device according to claim 1, wherein an electrical length of the slit is ⅛ or more but ⅜ or less of a wavelength corresponding to a wireless communication frequency used by the first antenna.

6. The electronic device according to claim 5, wherein the wavelength is a wavelength corresponding to a wireless communication frequency used by both the first antenna and the second antenna.

7. The electronic device according to claim 1, wherein
the slit includes
a base portion extending from the base point on the outer periphery of the ground pattern to a center side of the substrate, and
a bent portion bent from the base portion and extending to a side facing toward the first antenna, and
a distal end portion of the bent portion opposes the end portion on the side opposite to the side of the outer periphery of the substrate of the first antenna region.

8. The electronic device according to claim 1, wherein the ground pattern in which the slit is formed is formed by the conductor layer different from a conductor layer in which at least either one of the first antenna and the second antenna is formed.

9. The electronic device according to claim 1, further comprising:
a second slit formed by cutting out the conductor layer, with a base point that is a point on the outer periphery of the ground pattern,
wherein
the base point of the second slit is located between the first antenna region and the second antenna region in the plan view, and
the second slit has a portion opposing an end portion on a side opposite to a side of the outer periphery of the substrate of the second antenna region in the plan view.

10. The electronic device according to claim 9,
wherein
the portion in which the second slit opposes the end portion of the second antenna region is a portion in which a distal end portion of the second slit opposes the end portion on the side opposite to the side of the outer periphery of the substrate of the second antenna region, and
a position in a direction along the outer periphery of the substrate of a distal end of the second slit is located between an end portion on a side of the first antenna of the second antenna region and a feeding point of the second antenna.

11. The electronic device according to claim 9, wherein, in the portion in which the second slit opposes the end portion of the second antenna region, a distance between the slit and the second antenna region in the plan view is equal to or less than 1/16 of a wavelength corresponding to a wireless communication frequency used by the second antenna.

12. The electronic device according to claim 9, wherein an electrical length of the second slit is ⅛ or more but ⅜ or less of a wavelength corresponding to a wireless communication frequency used by the second antenna.

13. A method for manufacturing an electronic device, comprising:
providing a substrate;
forming a first antenna and a second antenna on the substrate, each configured to perform wireless communication;
forming a ground pattern by a single conductor layer of the substrate; and
forming a slit by cutting out the conductor layer, with a base point that is a point on an outer periphery of the ground pattern,
wherein
the first antenna is disposed within a first antenna region surrounded by an outer periphery of the substrate and the conductor layer in a plan view,
the second antenna is disposed within a second antenna region surrounded by the outer periphery of the substrate and the conductor layer in the plan view,
the base point of the slit is located between the first antenna region and the second antenna region in the plan view, and
the slit has a portion opposing an end portion on a side opposite to a side of the outer periphery of the substrate of the first antenna region in the plan view.

14. The method of claim 13, wherein
an opposing portion is a portion in which a distal end portion of the slit opposes the end portion on the side opposite to the side of the outer periphery of the substrate of the first antenna region, and
a position in a direction along the outer periphery of the substrate of a distal end of the slit is located between an end portion on a side of the second antenna of the first antenna region and a feeding point of the first antenna.

15. The method of claim 13, wherein in the opposing portion, a distance between the slit and the first antenna region in the plan view is equal to or less than 1/16 of a wavelength corresponding to a wireless communication frequency used by the first antenna.

16. The method of claim 15, wherein the wavelength is a wavelength corresponding to a wireless communication frequency used by both the first antenna and the second antenna.

17. The method of claim 13, wherein an electrical length of the slit is ⅛ or more but ⅜ or less of a wavelength corresponding to a wireless communication frequency used by the first antenna.

18. The method of claim 17, wherein the wavelength is a wavelength corresponding to a wireless communication frequency used by both the first antenna and the second antenna.

19. The method of claim 13, wherein
the slit includes
a base portion extending from the base point on the outer periphery of the ground pattern to a center side of the substrate, and
a bent portion bent from the base portion and extending to a side facing toward the first antenna, and
a distal end portion of the bent portion opposes the end portion on the side opposite to the side of the outer periphery of the substrate of the first antenna region.

20. The method of claim 13, wherein the ground pattern in which the slit is formed is formed by the conductor layer different from a conductor layer in which at least either one of the first antenna and the second antenna is formed.
